(19) United States
(12) Patent Application Publication
(10) Pub. No.: US 2008/0232207 A1
(43) Pub. Date: Sep. 25, 2008

(54) Method and Device For Compensating Tilt of an Optical Data Carrier

(76) Inventors: Teunis Willem Tukker, Eindhoven (NL); Ole Klembt Andersen, Voorburg (NL); Coen Theodorus Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,423

(22) PCT Filed: Oct. 1, 2004
(86) PCT No.: PCT/IB04/03240

§ 371 Date: Apr. 10, 2006

(30) Foreign Application Priority Data
Oct. 13, 2003 (EP) 03300152.0

(51) Int. Cl. G11B 7/095

(52) U.S. Cl. 369/44.33

(57) ABSTRACT

The invention relates to a method of and a device for compensating tilt of an optical or magneto-optical disc (1) exhibiting unknown tilt when placed in an apparatus for reading and/or writing data from and/or onto the optical or magneto-optical disc. A holographic optical element (23) containing a plurality of holograms each defining a phase profile able to compensate at least a specific coma amount is placed in a light path of an optical read/write unit (4) of the apparatus. The amount of tilt of the disc or coma introduced by the tilt is detected (14, 21), and a hologram defining a phase profile corresponding to the detected amount of tilt or coma is selected and accessed among the plurality of holograms of the holographic optical element for compensating the detected amount of tilt or coma. The invention applies to any type of optical data carrier such as so-called LD, CD, R-CD, DVD, DVD+R, DVD+RW, DVD-RW, DVR (Blue Ray).

### FIELD OF THE INVENTION

The invention relates to a method of compensating tilt of an optical data carrier, and a device for carrying out said method.

The present invention is applicable in the field of optical or magneto-optical disc systems, and applies to any type of optical data carrier such as a so-called LD (Laser Disc), CD (Compact Disc®), R-CD (Recordable CD), DVD (Digital Video Disc or Digital Versatile Disc), and (re)inscribable optical discs such as DVD+R, DVD+RW, DVD-RW, DVR (Blue Ray).

### BACKGROUND OF THE INVENTION

Disc drive systems are dedicated for storing information onto a disc-shaped storage medium or reading information from such disc-shaped storage medium. In such systems, the disc is rotated and a write/read head is moved radially with respect to the rotating disc.

An optical storage disc comprises at least one track, either in the form of a continuous spiral or in the form of multiple concentric circles, of storage space where information may be stored. Optical discs may be read-only type, where information is recorded during manufacture, which data can only be read by a user. The optical storage disc may also be a writable type, where information may be stored by a user.

For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of motor.

For optically scanning the rotating disc, an optical disc drive comprises a light beam generator device (typically a laser diode), an objective lens for focussing the light beam in a focal spot on the disc, and an optical detector for receiving the reflected light reflected from the disc and for generating an electrical detector output signal.

During operation, the light beam should remain focussed on the disc. To this end, the objective lens is arranged axially displaceable, and the optical disc drive comprises focal actuator means for controlling the axial position of the objective lens. Further, the focal spot should remain aligned with a track or should be capable of being positioned with respect to a new track. To this end, at least the objective lens is mounted radially displaceable, and the optical disc drive comprises radial actuator means for controlling the radial position of the objective lens.

More particularly, the optical disc drive comprises a sledge which is displaceably guided with respect to a disc drive frame, which frame also carries the spindle motor for rotating the disc. The travel course of the sledge is arranged substantially radially with respect to the disc, and the sledge can be displaced over a range substantially corresponding to the range from inner track radius to outer track radius. Said radial actuator means comprises a controllable sledge drive, for instance comprising a linear motor, a stepper motor, or a worm gear motor.

The displacement of the sledge is intended for roughly positioning the optical lens. For fine-tuning the position of the optical lens, the optical disc drive comprises a lens platform which carries the objective lens and which is displaceably mounted with respect to said sledge. The displacement range of the platform with respect to the sledge is relatively small but the positioning accuracy of the platform with respect to the sledge is larger than the positioning accuracy of the sledge with respect to the frame.

In many disc drives, the orientation of the objective lens is fixed, i.e. its axis is directed parallel to the rotation axis of the disc. In some disc drives, the objective lens is pivotably mounted, such that its axis can make an angle with the rotation axis of the disc. Usually, this is implemented by making the platform pivotable with respect to the sledge.

It is a general desire to increase the storage capacity of a record medium. One way of fulfilling this desire is to increase the storage density. To this end, optical scanning systems have been developed wherein the objective lens has a relatively high numerical aperture (NA). One problem involved in such optical systems is the increased sensitivity to tilt of the optical disc. Tilt of the optical disc can be defined as a situation where the storage layer of the optical disc, at the location of the focal spot, is not exactly perpendicular to the optical axis. Tilt can be caused by the optical disc being titled as a whole, but is usually caused by the optical disc being warped, having for instance the shape of a flattened dome or umbrella, and as a consequence the amount of tilt depends on the location of the focal spot on the disc.

As depicted in FIGS. 1A and 1B, the tilt can have a radial component and a tangential component. The radial component (radial tilt, FIG. 1A) is the component β of the deviation in a plane oriented transversely to the track to be read (i.e. along the radial direction R) and transversely to the data carrier, while the tangential component (tangential tilt, FIG. 1B) is defined as the component a of the deviation in a plane oriented parallel to the track to be read (i.e. along the tangential direction T) and transversely to the data carrier.

FIGS. 2A-2C illustrate the laser beam for an optical disc having no tilt and optical discs having a radial and a tangential tilt. When the disc is not tilted, the optical beam 206 remains focussed on the track 201 as shown in FIG. 2A. When the disc has radial or tangential tilt which leads to coma aberration, the optical beam is no more focused on the tracks 202 and 203, but has a tail 204 in case of radial tilt (FIG. 2B) or a tail 205 in case of tangential tilt (FIG. 2C).

As a consequence, for an optical disc system which uses a short wavelength laser diode and a high numerical aperture objective lens, it is necessary to detect and correct for the disc tilt, because the resulting coma aberration deteriorates the read and write performances, and the tilt margin becomes narrower.

Both the radial and tangential tilt of an optical disc can be compensated by known optical/mechanical solutions, such as by a method using a three-dimensional actuator or two driving units for the radial and tangential tilt compensation, respectively, from radial and tangential tilt signals delivered by a tilt sensor. Such a known method is disclosed in U.S. Pat. No. 4,608,680. However, with this known method, tuning the electronic servo-controls of this three-dimensional actuator or these two driving units is difficult. Moreover, this known method leads to limitations since specific mechanic and optical elements are required. The corresponding drive is thus of important size, easily damageable, and expensive.

### SUMMARY OF THE INVENTION

It is an object of the invention to provide an improved method of compensating tilt of an optical disc or magneto-optical disc.

This is achieved by providing a method as defined in claim 1, with a device as defined in claim 4, using a holographic optical element as defined in claim 10.

Use of holographic optical element or elements for compensating coma aberration and/or spherical aberration in an apparatus for reading and/or writing data from and/or onto a disc-shaped optical data carrier is already known for example from U.S. Pat. No. 6,084,843, U.S. Pat. No. 6,130,872, and U.S. Pat. No. 6,185,176. However, in these known apparatus, the holographic optical element or elements are designed and used for solving technical problems different from the technical problem the invention aims to solve.

More precisely, instead of being designed to compensate coma aberrations that arise due to unknown, unpredictable tilt of an optical disc placed in the optical data read/write apparatus as the holographic optical element of the invention does it, the holographic optical element or elements used in the known apparatus are designed for eliminating a fixed, predetermined amount of coma that arises due to an off-axis position of one or the light sources used in the apparatus, and for eliminating also a fixed amount of spherical aberration that arises when reading out a CD with an objective lens optimized for a DVD disc (U.S. Pat. No. 6,084,843), and for generating also a fixed amount of astigmatism for tracking servo control purposes (U.S. Pat. No. 6,130,872 and U.S. Pat. No. 6,185,176).

It is also known to use a holographic optical element having a number of different holograms recorded therein (U.S. Pat. No. 5,487,060). Each hologram is selectively accessible and, when accessed, is able to impart a predetermined particular amount of spherical aberration to the light beam incident on an optical data storage disc having therein a plurality of data surfaces on substrates separated by light transmissive elements. The number of recorded holograms corresponds to the number of different spherical aberration corrections required, that is itself dependent on the number of data surfaces at different depths within the thickness of the disc. For instance, four holograms are needed when the optical disc has four pairs of data surfaces. So, it is possible to eliminate the spherical aberration experienced by the light beam passing through different materials or mediums having different indices of refraction, when the light beam is focussed onto a corresponding particular data surface selected among the data surfaces of the disc. Again, this is a solution to a technical problem different from that one solved by the present invention.

Other advantageous developments of the invention can be found in dependent claims 2, 3, 5 and 6.

The invention also provides an apparatus for reading and/or writing data from and/or onto an optical or magneto-optical disc, as defined in claims 7 to 9.

The invention also provides an holographic optical element as defined in claim 10.

These and other aspects of the invention will be apparent from and will be elucidated with reference to the embodiments described hereinafter.

### BRIEF DESCRIPTION OF THE DRAWINGS

The invention will now be described in more detail, by way of example, with reference to the accompanying drawings, in which:

FIGS. 1A and 1B illustrate a radial tilt and a tangential tilt, respectively, in an optical data carrier,

FIGS. 2A-2C illustrate an optical spot without coma aberration (FIG. 2A), with radial coma aberration (FIG. 2B), and with tangential coma aberration (FIG. 2C) on an optical data carrier,

FIG. 3 is a block diagram of an apparatus in accordance with the invention, with a schematic layout of a light path in said apparatus,

FIG. 4 shows a series of wave-fronts, one of them exhibiting distortion due to aberrations,

FIG. 5 is a schematic perspective view of a circular optical element useful for defining parameters that are taken into account for calculating coma aberrations,

FIG. 6 is a schematic perspective view of a holographic optical element that can be used for carrying out the method of the invention.

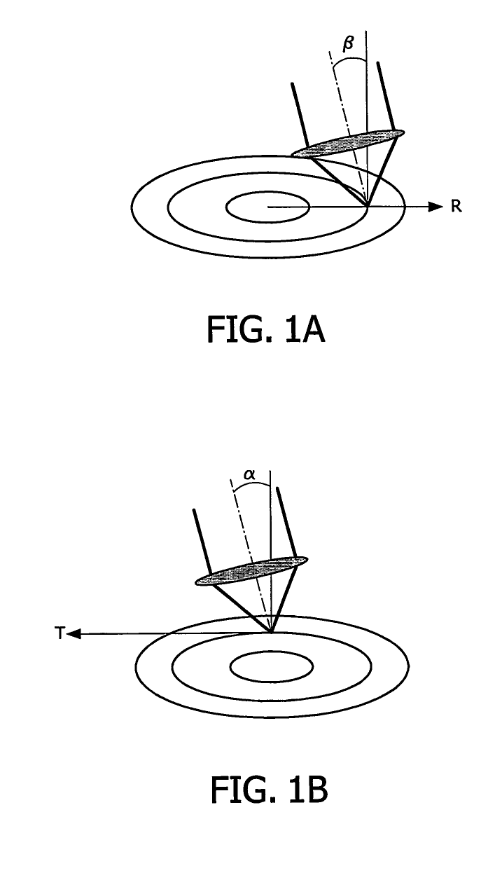

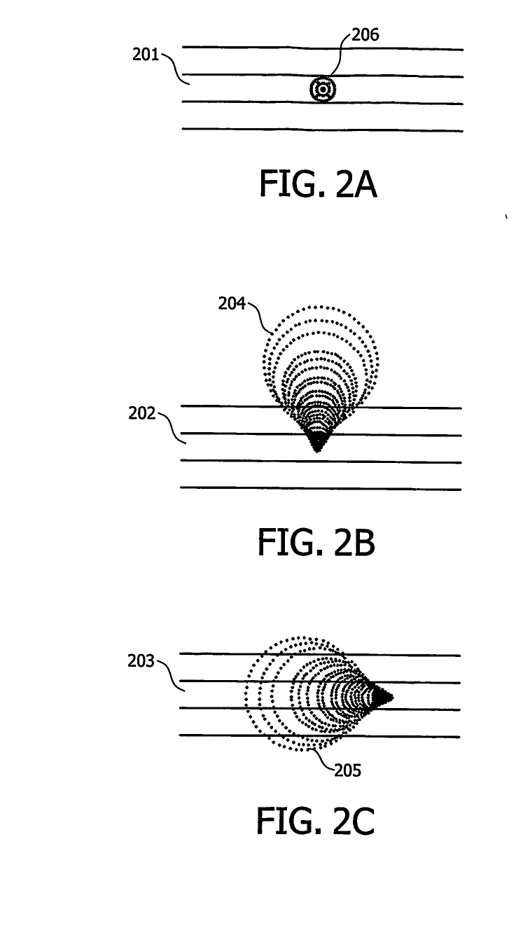

### DETAILED DESCRIPTION OF THE INVENTION

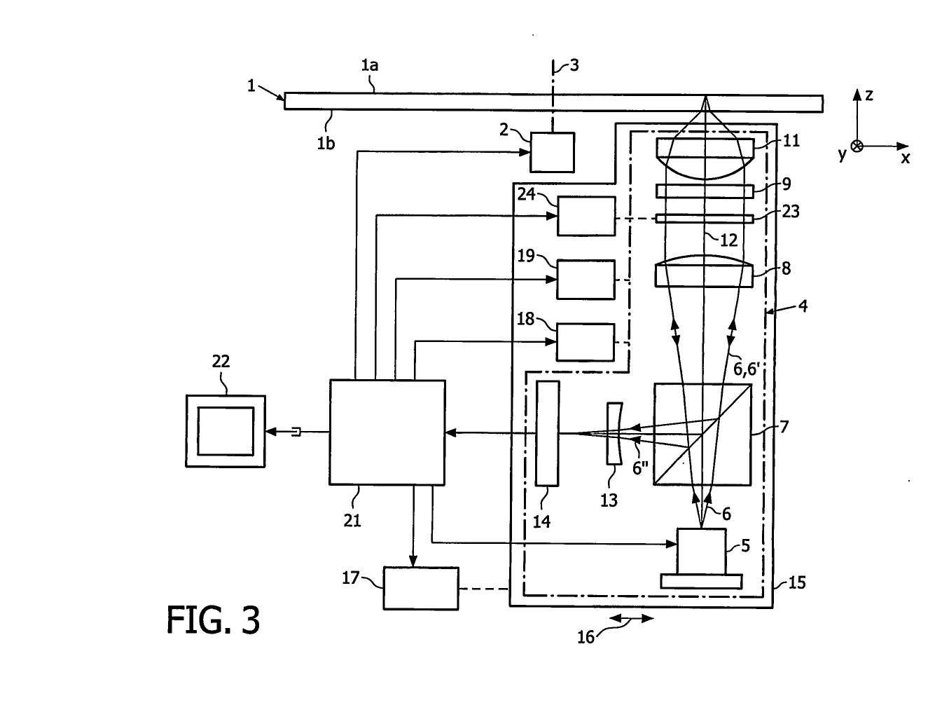

FIG. 3 shows an apparatus, in which a data carrier 1 is placed and supported in a conventional manner by a support not shown. This data carrier 1 may be an optical disc such as a so-called LD, CD, R-CD, DVD, DVD+R, DVD+RW, DVD-RW, DVR or the like. Disc 1 is shown in cross section in FIG. 3, and can be rotated by a motor 2 about an axis 3 which normally extends perpendicularly to the upper and lower faces 1a and 1b of disc 1, which are usually parallel to each other.

The apparatus or optical disc player comprises an optical unit or head 4 which can be designed solely for reading an optical disc or for both writing and reading, and possibly also re-writing an optical disc placed in the apparatus. In the example shown in FIG. 3, the optical unit 4 is designed for use with optical discs of the DVD+RW type. As shown, unit 4 comprises essentially a laser light source 5, such a laser diode, which produces a laser light beam 6 that is directed toward disc 1 through a polarizing beam splitter (PBS) 7, a collimator lens 8, a quarter-wave plate 9, and an objective lens 11. Objective lens 11 focuses the incident light beam 6 on a data surface inside disc 1. Disc 1 may have one or more data surfaces formed therein, the data surface or surfaces being parallel to the upper and lower faces 1a and 1b of disc 1. The optical axis 12 of the light path, at least between optical unit 4 and disc 1, is normally perpendicular to disc 1 and parallel to axis of rotation 3 of disc 1, i.e. parallel to the direction indicated by Z in FIG. 3.

Light 6′ reflected by the data surface of disc 1 goes back through objective lens 11, quarter-wave plate 9 and collimator lens 8 to polarizing beam splitter 7 which reflects light beam 6′ and delivers a twice-reflected light beam 6″ at right angle with respect to light beam 6′. Twice-reflected light beam 6″ is passed through a lens 13 which focuses beam 6″ onto a sensitive surface of a photodetector 14.

Optical unit 4 is movably supported in a sledge 15 by means of a number of actuators as explained hereinunder. Sledge 15 is mounted on suitable guides not shown for movement in the apparatus along a direction which is indicated by arrow 16 and which is parallel to a radial direction of disc 1, denoted by X in FIG. 3. Coarse radial positioning of sledge 15, and hence also of optical unit 4 with respect to disc 1 can be performed by sledge motor 17.

As indicated above, sledge 15 carries a number of actuators, namely a first actuator 18 for fine radial positioning of optical unit 4 with respect to disc 1 (tracking control), and a second actuator 19 for moving optical unit 4 in a direction parallel to axis 3, also denoted by Z in FIG. 3, for focus setting. In case of an optical video disc player, another actuator (not shown) is also provided for moving the optical unit 4 in a direction Y perpendicular to directions X and Z, i.e. in a tangential direction to the track of the optical disc 1, for time base correction servocontrol.

Output signals from photodetector 14 are fed to electronic circuitry 21 contained in the apparatus. Electronic circuitry 21 comprises signal processing circuits for processing the output signals from photodetector 14 and for deriving therefrom audio, video and/or information signals to be converted to sound through suitable loudspeakers and/or displayed as images on the screen of a suitable monitor 22. The processing circuits also provide suitable control signals for controlling the above various motors and actuators 17-19.

As indicated above, objective lens 11 of optical unit 4 is designed for normal incidence of the laser light beam on disc 1 along direction Z. However, if the disc is tilted either as a whole or locally with respect to optical axis 12, it introduces coma that has to be compensated for proper writing and/or reading data on and/or from the disc.

To this end, the invention provides a holographic optical element 23 (hereinunder referred to as HOE) in the light path of the optical unit 4, for instance between collimator lens 8 and quarter-wave plate 9. HOE 23 contains a plurality of holograms defining a corresponding plurality of phase profiles, each phase profile being able to compensate a specific amount of coma corresponding to a tilt amount likely to be exhibited by a disc placed in the apparatus. For instance, HOE 23 may contain approximately 1 000 holograms or more.

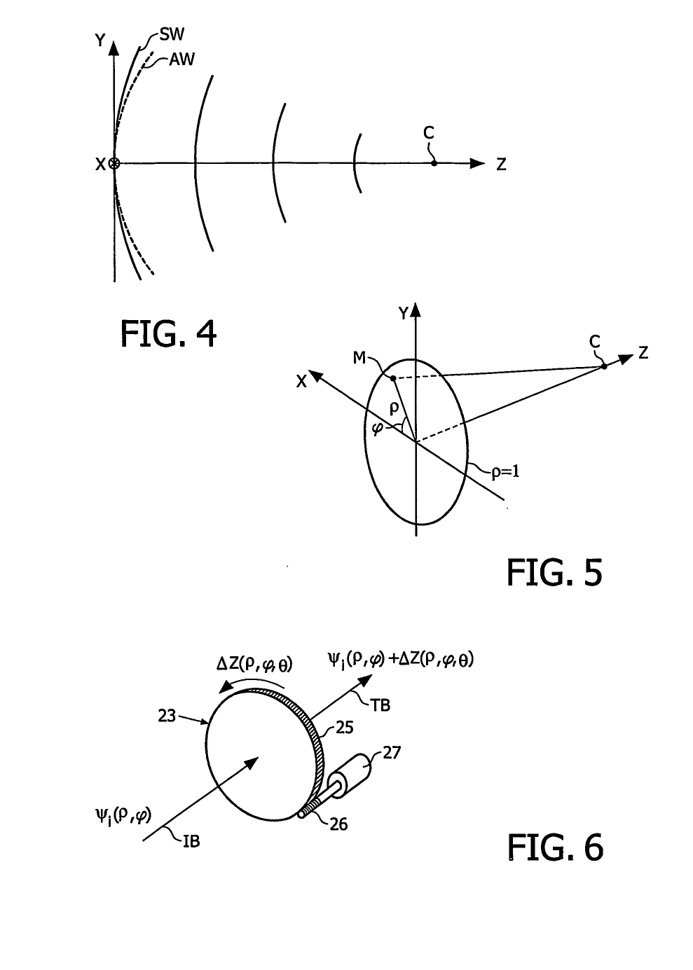

A “phase profile” can be defined as follows with reference to FIGS. 4 and 5. FIG. 4 shows a series of wave-fronts (surfaces of constant phase). The wave-fronts indicated with the solid black lines correspond to a spherical wave SW that is travelling toward point C. This represents the “ideal” situation (ideal in the sense that it is equivalent to an incident beam focussed to point C). The wave-front indicated with the dotted line AW (Aberrated Wave) represents a deviation from the ideal case. The deviation is called the “wave-front error”. Since wave-fronts are surfaces of constant phase, it means that the dotted wave-front is derived from the solid wave-front (or vice versa) by modifying the phase corresponding to the solid (or dotted) wave-front.

If one chooses to use the well known Zernicke polynomials to represent the wave-front error, it then turns out, that for the situation where the lowest-order coma aberration is the cause of the deviation, the wave-front error can be written as:

Z(ρ,φ)=A₃₁(3ρ²−2ρ)cos φ

or

Z(ρ,φ)=A₃₁(3ρ²−2ρ)sin φ

in which ρ and φ are the polar coordinates of any point M of the wave-front as shown in FIG. 5, and A₃₁ is the amplitude of the error. As a function of the radial coordinate ρ, the above polynomials give the phase deviation from the ideal case (the phase profile). For example, at the rim of a lens, where ρ=1, the wave-front error is:

Z(ρ=1,φ)=A₃₁ cos φ or Z(ρ=1,φ)=A₃₁ sin φ

Accordingly, by placing in the light path a plurality of selectively accessible holograms defining a corresponding plurality of phase profiles, each corresponding to a specific amount of coma, and by selecting (accessing) an appropriate hologram among the plurality of holograms it is possible to introduce in the light beam an amount of coma that will compensate or eliminate a coma introduced by an amount of tilt exhibited by disc 1.

In one embodiment of the invention, the amount of tilt (radial tilt, tangential tilt or both) exhibited by the disc 1 currently placed in the apparatus is detected dynamically. This can be done for instance by using photodetector 14 also as a tilt sensor. In this case, photodetector 14 may be segmented into four segments or quadrants producing individual output signals and these individual output signals can be processed by the processing circuits included in electronic circuitry 21 so as to derive therefrom radial and tangential tilt signals in a manner quite similar to the tilt evaluating method described in the specification of U.S. Pat. No. 4,608,680 to which one may refer for more details.

Then, having so detected and evaluated the amount of tilt exhibited by disc 1, a hologram defining a phase profile corresponding to the detected amount of tilt is selected among the holograms contained in HOE 23 and used for eliminating the detected amount of tilt.

The holograms contained in HOE 23 are so recorded therein, that they can be selectively accessed by changing a relative spatial relationship between HOE 23 and a polarization direction of light beam 6.

As the light beam 6 going from polarizing beam splitter 7 toward quarter-wave plate 9 is linearly polarized in one direction perpendicular to optical axis 12, one way for accessing a desired hologram among the holograms recorded in HOE 23 is to provide the apparatus with a suitable drive means 24 (FIG. 3) for rotating HOE 23 about optical axis 12 until the desired hologram is accessed. For instance, HOE 23 may be implemented as a circular plate or substrate having a transmissive holographic coating and mounted in a ring having a suitable toothing 25 at its peripheral edge, that is drivingly engaged by a suitable pinion or worm 26 which can be driven by a motor 27, as shown in FIG. 6.

Alternatively, another way for selecting a desired hologram could be to rotate the direction of polarization of light beam 6, while having a fixed HOE 23. In this case, the apparatus can be provided with a circular light-transmissive half-wave plate (not shown) placed for instance between collimator lens 8 and HOE 23, and with drive means similar to toothing 25, pinion or worm 26 and motor 27 of FIG. 6, for rotating the circular half-wave plate about optical axis 12, thereby causing the polarization direction of beam to rotate about optical axis 12.

Whatever element is rotated, i.e. the HOE 23 or the above-mentioned circular half-wave plate, the desired hologram for compensating the detected tilt amount can be accessed as follows. For example, the above-mentioned tilt signals derived from the output signals of segmented photodetector 14 can be produced by a microprocessor included in the electronic circuitry 21. The microprocessor or the electronic circuitry 21 can also comprise a memory storing a look-up table or map in which disc tilt amounts are correlated with the holograms of HOE 23. For instance, the correlation may be such that to any disc tilt amount in the look-up table corresponds an angular position value of the HOE 23 (or of the half-wave plate) that enables to access the appropriate hologram to compensate the coma generated by that disc tilt amount. Thus, on the basis of the detected disc tilt amount, the microprocessor is able to find out in the look-up table a corresponding angular position value and, then, to control the rotation of the HOE 23 (or of the half-wave plate) by motor 27 until it reaches the desired angular position found out in the look-up table. An angular position sensor may be coupled to HOE 23 (or to half-wave plate) and connected to the microprocessor to enable the latter to check that the correct angular position has been reached.

In another embodiment of the invention, the holograms could be recorded in the HOE 23 in such a manner that when the HOE 23 (or the half-wave plate) is rotated step by step in a first direction the amount of compensating coma introduced by said HOE in the light beam is increased, whereas it is decreased when the HOE 23 (or the half-wave plate) is rotated in the opposite direction. In this case, the detected tilt amount may be used as an error signal, and the electronic circuitry 21 or a microprocessor included therein may control the rotation of the HOE 23 (or the half-wave plate) step by step in such a direction as to minimize the detected tilt amount.

In yet another embodiment of the invention, instead of detecting the tilt amount of disc 1, one might detect and evaluate the amount of coma introduced in the light beam by the tilt of the disc, or any other physical quantity related to coma. For example, it is known that coma increases the amount of jitter (through cross-talk and inter-symbol interference). Therefore, one might measure the amount of jitter and use the measured amount of jitter as an error signal for controlling the rotation of the HOE 23 (or the half-wave plate) both in a direction and by an angle value that will minimize jitter. However, such a method only works for discs which contain data.

In yet another embodiment of the invention which can be implemented in combination with any one of the preceding embodiments, when the apparatus of the invention is able to read/write optical discs having a plurality of data surfaces, the holograms recorded in the HOE 23 may be designed for compensating both coma and spherical aberrations. To this end, each of the holograms recorded in the HOE 23 or at least some of them may define a phase profile that is given by the sum or “superposition” of the above-indicated Zernicke polynomial corresponding to the lowest-order coma aberration and Zernicke polynomial corresponding to the lower-order spherical aberration which can be written as:

Z(ρ,φ)=A₄₀(6ρ⁴−6ρ²+1)

Where ρ and φ have the same definition as that one given above in relation with FIG. 5, and A₄₀ is the amplitude of the wave-front error due to spherical aberration. In this case, selection of an appropriate hologram among the holograms recorded in the HOE 23 can be performed on the basis of the detected amount of tilt and on the basis of a known predefined spherical aberration corresponding to a selected data surface in the optical disc. Here again, such a selection can be performed for instance by using a look-up table.

It is to be understood that the present invention may be embodied with various other changes, modifications and improvements which may occur to those skilled in the art, without departing from the scope of the invention defined by the following claims.

For instance, the change of relative spatial relationship between the HOE 23 and a polarization direction of light beam 6 for accessing a desired hologram among the holograms recorded in said HOE could be performed by rotating the HOE 23 about an axis parallel to the X or Y axis instead of rotating it about the optical axis 12 (or Z axis).

Also, instead of using a HOE made of a plate or substrate having a transmissive holographic coating, one could use a HOE made of a substrate having a reflective holographic coating.

Furthermore, it is not absolutely necessary to use a polarizing beam splitter for implementing the invention, as one could use also a non polarizing beam splitter. However, a polarizing beam splitter is preferable as it has a better light path efficiency.

The use of the verb “to comprise” or “to include” and its conjugations does not exclude the presence of elements or steps other than those stated in a claim. Furthermore, the use of the article “a” or “an” preceding an element or step does not exclude the presence of a plurality of such elements or steps. The invention may be implemented by means of hardware as well as software. Not every “means” stated in a claim will necessarily correspond to a separate element of hardware in the apparatus. The same item of hardware may encompass several “means”. In the claims, any reference signs placed between parentheses shall not be construed as limiting the scope of the claims.

1. A method of compensating tilt of an optical or magneto-optical disc exhibiting unknown tilt when placed in an apparatus for reading and/or writing data from and/or onto said optical or magneto-optical disc, comprising the steps of:
a) detecting an amount of one element of the group comprising the tilt of said disc, a coma aberration resulting from said tilt, and a physical quantity related to said coma aberration,
b) providing a holographic optical element in a light path of an optical read/write unit of said apparatus, said holographic optical element containing a plurality of holograms each defining a phase profile able to compensate at least a specific coma amount,
c) selecting among said plurality of holograms a hologram defining a phase profile corresponding to the amount of tilt or coma detected in step a), and
d) using the selected hologram for compensating the detected amount of tilt or coma.

2. The method of claim 1, wherein said selecting step is performed by changing a relative spatial relationship between said holographic optical element and a polarization direction of a light beam impinging on said holographic optical element in said optical read/write unit.

3. The method of claim 2, wherein said relative spatial relationship is changed by rotating said holographic optical element.

4. A device for compensating tilt of an optical or magneto-optical disc exhibiting unknown tilt when placed in an apparatus for reading and/or writing data from and/or onto said optical or magneto-optical disc, comprising:
a) means for detecting an amount of one element of the group comprising the tilt of said disc, a coma aberration resulting from said tilt, and a physical quantity related to said coma aberration,
b) holographic optical element disposed in a light path of an optical read/write unit of said apparatus, said holographic optical element containing a plurality of holograms each defining a phase profile able to compensate at least a specific coma amount, and
c) means for selecting among said plurality of holograms a hologram defining a phase profile corresponding to the amount of tilt or coma which has been detected by said detecting means and which is to be compensated.

5. The device of claim 4, wherein said selecting means comprises means for changing a relative spatial relationship between said holographic optical element and a polarization direction of a light beam impinging on said holographic optical element.

6. The device of claim 5, wherein said changing means comprises means for rotating said holographic optical element.

7. An apparatus for reading and/or writing data from and/or onto an optical or magneto-optical disc, said apparatus comprising:
a) an optical unit able to read and/or write data from and/or onto an optical or magneto-optical disc placed into said apparatus, and
b) means for compensating tilt of said disc, said compensating means comprising:
b1) means for detecting an amount of one element of the group comprising the tilt of said disc, a coma aberration resulting from said tilt, and a physical quantity related to said coma aberration,
b2) a holographic optical element disposed in a light path of said optical read/write unit of said apparatus, said holographic optical element containing a plurality of holograms each defining a phase profile able to compensate at least a specific coma amount, and
b3) means for selecting among said plurality of holograms a hologram defining a phase profile corresponding to the amount of tilt or coma which has been detected by said detecting means and which is to be compensated.

8. The apparatus of claim 7, wherein said selecting means comprises means for changing a relative spatial relationship between said holographic optical element and a polarization direction of a light beam impinging on said holographic optical element.

9. The apparatus of claim 8, wherein said changing means comprises means for rotating said holographic optical element.

10. A holographic optical element for use in an apparatus for reading and/or writing data from and/or onto at least one optical or magneto-optical disc placed in said apparatus, said disc exhibiting unknown tilt when placed in said apparatus, said holographic optical element comprising a substrate containing a plurality of holograms defining a corresponding plurality of phase profiles, each phase profile being able to compensate a specific amount of coma corresponding to a tilt amount likely to be exhibited by a disc placed in said apparatus.
